(19) United States
(12) Patent Application Publication
(10) Pub. No.: US 2010/0109277 A1
(43) Pub. Date: May 6, 2010

(54) Adjustable Monotube Shock Absorber

(76) Inventor: Fredrick J. Furrer, Portage, WI (US)

Correspondence Address: BOYLE FREDRICKSON S.C., 840 North Plankinton Avenue, MILWAUKEE, WI, 53203, US

(21) Appl. No.: 12/613,733

(22) Filed: Nov. 6, 2009

Related U.S. Application Data
(60) Provisional application No. 61/111,888, filed on Nov. 6, 2008.

(51) Int. Cl. B60G 17/033; F16F 9/06

(52) U.S. Cl. 280/124.161; 188/314

(57) ABSTRACT

A monotube shock absorber that can be adjusted remotely or otherwise, and a corresponding system are provided. The monotube shock absorber includes a body tube that houses a working piston therein and a bypass tube that is attached to but external with respect to the body tube. A control valve influences flow volume and rate of oil that passes through the bypass tube in a manner that correspondingly influences damping and/or other characteristics of the monotube shock absorber. The monotube shock absorber can include a floating piston separating a volume of gas from a volume of oil. The volumes of gas and oil may be entirely housed in the body tube or may be at least partially housed in an external reservoir that can include an anti-cavitation valve.

### CROSS-REFERENCE TO RELATED APPLICATIONS

This application claims the benefit of and priority to U.S. Provisional Patent Application Ser. No. 61/111,888, filed on Nov. 6, 2008, the entirety of which is expressly incorporated by reference herein.

### BACKGROUND OF THE INVENTION

1. Field of the Invention

This invention relates to remotely adjustable shock absorbers and, more particularly, to remotely adjustable monotube shock absorbers and systems incorporating the same.

2. Discussion of the Related Art

Remotely adjustable shock absorbers continue to grow in popularity. Numerous previous attempts have been made to provide such adjustable shock absorbers. Knecht, U.S. Pat. No. 4,650,042, Ashiba, U.S. Pat. No. 4,519,186, and Emura, U.S. Pat. No. 4,620,619, all disclose shock absorbers which utilize electrically powered actuators in the shock absorber to modify damping characteristics. Similarly, Ellis, U.S. Pat. No. 4,122,923, and Schupner, U.S. Pat. No. 4,164,274, disclose adjustable shock absorbers having manually adjusted mechanical linkages to set the damping characteristics. Such known approaches use either electric motor or manually adjusted mechanical linkages to position valving elements at predetermined locations in the shock absorber. In many cases, such adjustable shock absorbers suffer from the need for a relatively expensive hollow piston rod. Furthermore, each unit must be made to close tolerances so that all the units on a given vehicle change in the same manner as the electric motors or mechanical linkages are adjusted.

Williams, U.S. Pat. No. 4,753,328, discloses a shock absorber system in which pneumatic circuits are used to modify the load carrying ability of the shock absorbers, not to change damping characteristics. In some ways, Williams is similar to Kuroki, U.S. Pat. No. 4,600,215, and Kanai, U.S. Pat. No. 4,566,718, both of which disclose conventional air spring systems in which pneumatic circuits are used to vary the characteristics of a plurality of air springs simultaneously.

Many of such prior art remotely adjustable shock absorbers have multi-tube configurations. As yet another example of a known multi-tube adjustable shock absorber, Applicant's own U.S. Pat. No. 4,838,394 discloses triple-tube adjustable shock absorbers.

Although such multi-tube adjustable shock absorbers can be well suited for their intended end use applications, for at least some applications including various high performance applications, shock absorbers having monotube configurations prove more desirable. This is because an important factor in shock absorber design is an available shock mounting clearance(s) or mounting space dimension(s) within the end use vehicle. In light of such available shock mounting clearance(s), an outside diameter or width dimension of a shock absorber is a critical factor in shock design. In other words, for a given vehicle, there is only so much space in which a shock absorber can mount, and correspondingly the shock absorber can only be so wide in order to fit in that allotted space.

When comparing multi-tube shock absorbers with monotube shock absorbers having equivalent width or outside diameters, the pistons within working cylinders of the multi-tube shock absorbers, e.g., triple-tube shock absorbers or twin-tube shock absorbers, are smaller in diameter than those of the monotube shock absorbers. This is because multi-tube shock absorbers have working cylinders that are concentrically housed within and spaced from outer tubes, whereas in monotube shock absorbers, the outer tube is the working cylinder itself. Correspondingly, again comparing multi-tube and monotube shock absorbers having the same overall widths or outside diameters, working pistons of monotube shock absorbers have larger diameters than those of multi-tube shock absorbers. Thus, when compared to relatively larger diameter working pistons of monotube shock absorbers, the relatively smaller diameter pistons of multi-tube shock absorbers displace relatively less oil per an equivalent axial stroke of such pistons. Furthermore, multi-tube shock absorbers typically house relatively less oil therein and correspondingly have relatively diminished heat dissipation capability when compared to monotube shock absorbers.

Some attempts have been made to provide monotube shock absorbers with adjustable damping characteristics. Such adjustable monotube shock absorbers typically include adjustable damping valves or devices incorporated into the working pistons. In these known configurations, hollow piston rods serve as conduits or housings to concentrically hold elongate mechanical linkages or other actuators for manipulating the adjustable valves. Such systems are highly complex and expensive. Furthermore, hollow piston rods can be expensive to produce and are relatively more proven to impact type and other damage, as compared to solid rod configurations, which can compromise the use-life of such designs.

Yet other attempts have been made to provide adjustable monotube shock absorbers by way of external bypass tubes that have adjustable valving in the tubes themselves. Such known implementations have multiple external bypass tubes that extend across different segments of the shock body tubes, for establishing “zoning” or zone adjustability which allows users to tune the shock damping for proving different damping characteristics at different portions or segments of the piston stroke. In other words, the zoning functionality of known adjustable monotube shock absorbers with external bypass tubes offers differing performance characteristics base on where a working piston is axially positioned within the shock body tube at a given time and therefore which hydraulic circuit, defined at least partially by one of the external bypass tubes, the working piston forces oil through at any given time. Adjusting the zoning type damping characteristics of these shock absorbers is done at the shock absorber itself, more particularly, at each of the external bypass tubes. Commonly a knob, dial, or other rotating actuator is provided that the user manually rotates to adjust the valving within the external bypass tube. These zoning adjustable systems are typically complex, are incapable of remote adjustability, and are expensive, whereby their most common implementations are within racing and motorsports applications.

### SUMMARY OF THE INVENTION

It would prove desirable to provide a monotube shock absorber that can be controlled remotely and can be incorporated into a system that controls multiple monotube shock absorbers in a motor vehicle, and overcomes the aforesaid problems of the prior art. The present invention is a monotube shock absorber that includes a body tube having a cylindrical sidewall. The body tube defines a gas cavity that houses a volume of gas therein, and an oil cavity positioned axially adjacent to the gas cavity for housing a volume of oil therein.

The shock absorber of the present invention further includes a rod that has a first end housed in the body tube and a second end extending outwardly from an end of the body tube. An optional floating piston can be concentrically housed between the rod and an inwardly facing surface of the cylindrical sidewall of the body tube. The floating piston defines an interface between the gas and oil cavities and maintains a physical separation between the volumes of gas and oil. The floating piston can further define a floating zone that corresponds to a portion of the body tube in which the floating piston axially traverses during use.

The present invention further includes a working piston connected to and travelling in unison with the first end of the rod, and is positioned within and movable through the volume of oil. The working piston separates the oil cavity into an upper oil cavity portion that is positioned above the working piston and a lower oil cavity portion that is positioned below the working piston.

The monotube shock absorber further comprises an external bypass tube positioned outside of the cylindrical sidewall of the body tube. The external bypass tube includes a lower end fluidly connected to the lower oil cavity and an upper end fluidly connected to the upper oil cavity. The upper end of the bypass tube intersects the cylindrical sidewall of the body tube at a location that is below a lowermost segment of the floating zone in which the floating piston operates. The external bypass tube may define a bidirectional flow of oil therethrough as the working piston travels in a first axial direction and a second, opposing axial direction through the oil cavity, or, optionally, a mono-directional flow path when a foot valve is incorporated into the monotube shock absorber.

The present invention also includes a control valve assembly provided between the lower bypass tube end and the lower oil cavity portion. The control valve assembly may be adjusted to control the oil flow therethrough and corresponding damping characteristics of the monotube shock absorber. In at least some implementations, the control valve assembly of the present invention may be provided within a base attached to a bottom end of the body tube.

In a second embodiment of the present invention, the monotube shock absorber includes an external bypass tube, and an external reservoir having an optional anti-cavitation valve cooperating therewith.

In yet other embodiments, the external bypass tube includes a first end attached to a location of the body tube's cylindrical sidewall that is located above the piston head when the piston head is located at an uppermost position within the body tube during a rebound stroke. During the rebound stroke, the piston head forces a volume of oil through a single flow path that is defined through the external bypass tube and the control valve such that manipulating the control valve adjusts the rebound stroke characteristics of the monotube shock absorber.

Another embodiment of the present invention is directed to a remotely controlled monotube shock absorber system. The present embodiment comprises a user interface and a controller operably communicating therewith for managing performance characteristics of multiple adjustable monotube shock absorbers, either simultaneously or otherwise.

### BRIEF DESCRIPTION OF THE DRAWINGS

The drawings illustrate a preferred and exemplary embodiment of the invention.

In the drawings:

FIG. 1 is a schematic view of a system incorporating multiple remotely adjustable monotube shocks according to the invention;

FIG. 2 is a cross-sectional view of a first embodiment of remotely adjustable monotube shocks according to the invention;

FIG. 3 is a cross-sectional view of a second embodiment of remotely adjustable monotube shocks according to the invention;

FIG. 4 is a cross-sectional view of a variant of the remotely adjustable monotube shock of FIG. 3, including a foot valve;

FIG. 5 is an enlarged cross-sectional view of a variant of the remote reservoir of FIG. 3, including an anti-cavitation valve.

### DETAILED DESCRIPTION OF THE PREFERRED EMBODIMENTS

The present invention and the various features and advantageous details thereof are explained more fully with reference to the non-limiting embodiments described in detail in the following description.

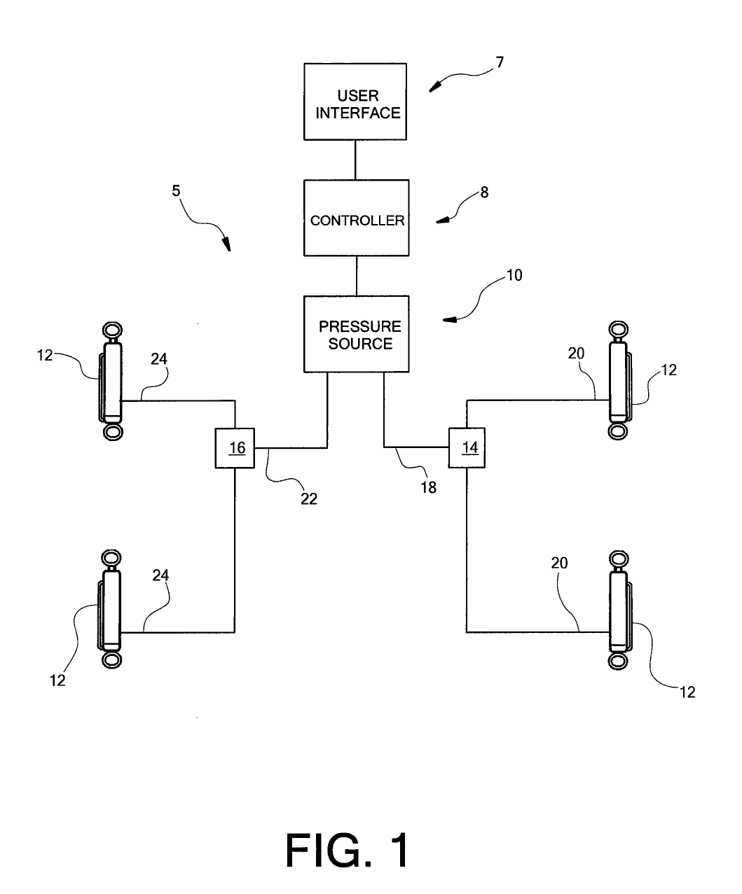

Turning now to the drawings, FIG. 1 shows a system 5 that incorporates multiple adjustable monotube shock absorbers, e.g., monotube shock absorbers 12, a user interface 7, a controller 8, and a fluid pressure source 10. Typically, the multiple monotube shock absorbers 12 are arranged as, e.g., two shock absorbers 12 mounted to the front suspension elements of a vehicle, and two shock absorbers 12 mounted to the rear suspension elements of the vehicle. The user interface 7 can be mounted on the center console of the vehicle, so as to be accessible by the driver for manual adjustment, or elsewhere in the passenger compartment that allows suitable accessibility by the user. Alternatively, the user interface 7 can be integrated into the electronic controls of the vehicle, whereby such existing electronic controls automatically control the system 5 or allow the user to control the system 5 at least partially through the existing controls. For example, in such embodiments, damping characteristics of the monotube shock absorbers 12 can be varied automatically as a function of vehicle speed to, e.g., offer a firmer ride at relatively higher vehicular speeds and a softer ride at relatively lower vehicular speeds.

Still referring to FIG. 1, controller 8 is operably connected to the user interface 7 and is configured to manage or control the remainder of the system 5. The particular communication path established between the user interface 7 and controller 8 is selected based on the desired end-use configuration of system 5. Communication between the user interface 7 and controller 8 can be accomplished by way of, e.g., fluid or electrical conductors and/or corresponding devices, optionally wireless techniques such as radio-frequency or infrared, if a suitable unobstructed line of sight is provided between the user interface 7 and controller 8. Regardless of the particular communication path between user interface 7 and controller 8, they preferably cooperate with each other to manipulate or otherwise control various functions of, e.g., a centralized pressure source 10, distribution manifolds 14, 16, and/or components within the system 5.

Centralized pressure source 10 is utilized for adjusting performance characteristics of the monotube shock absorbers 12 by supplying a pressurized control fluid such as hydraulic fluid or air to the distribution manifolds 14 and 16. For example, the pressure source 10 is connected to a first distribution manifold 14, which can be a three-way or other suitable manifold, by a hydraulic line 18. Multiple hydraulic lines 20 connect the distribution manifold 14 to the monotube shock absorbers 12 at the front of the vehicle. Similarly, pressure source 10 is connected to another distribution manifold 16, which can be a three-way or other suitable manifold, by a hydraulic line 22. Multiple hydraulic lines 24 connect the distribution manifold 16 to the monotube shock absorbers 12 at the rear of the vehicle.

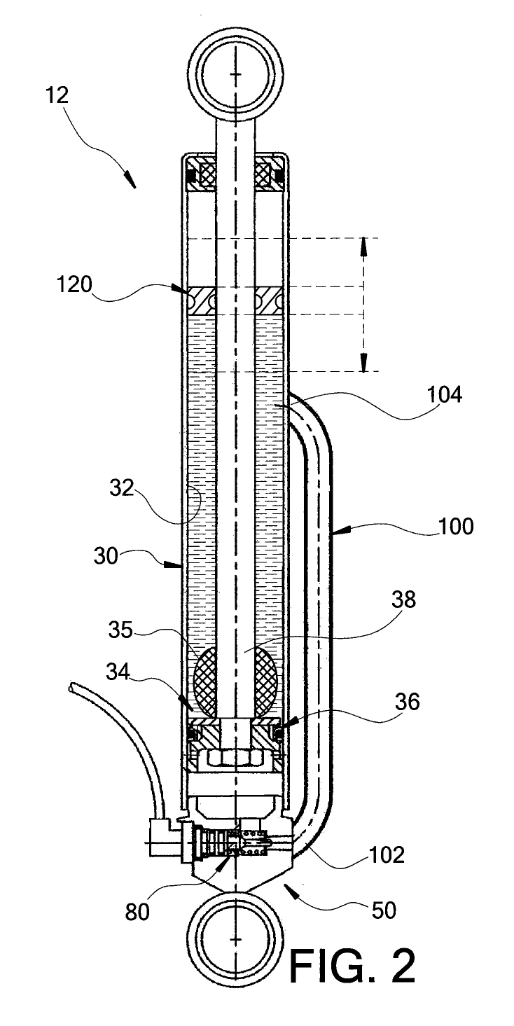

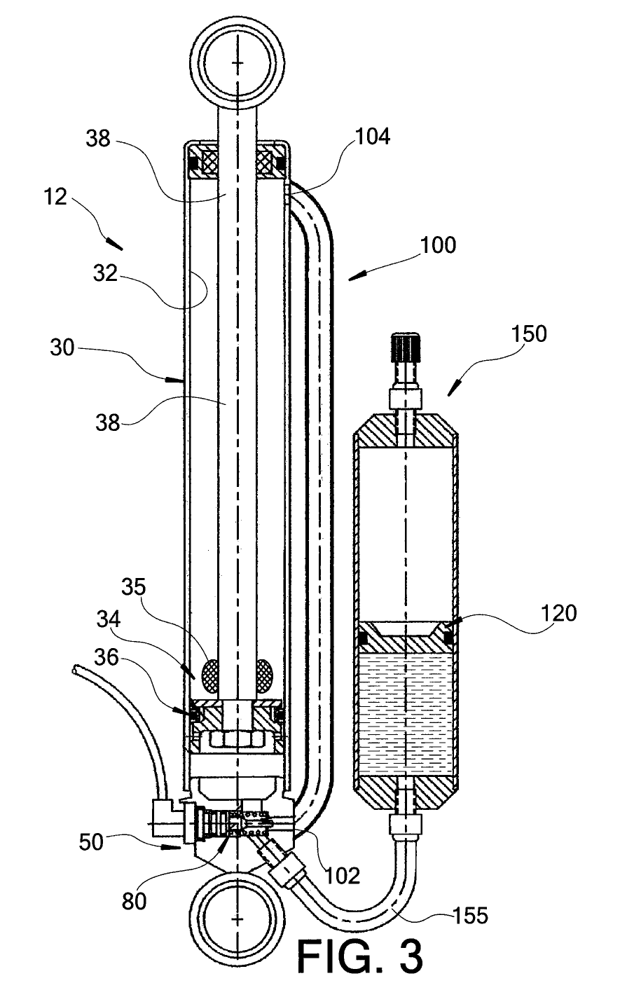

Preferably, all of the monotube shock absorbers 12 within system 5 are essentially the same or largely analogous. Accordingly, a single monotube shock absorber is shown in each of FIGS. 2 and 3.

Referring now to FIGS. 2-4, each monotube shock absorber 12 includes a cylindrical sidewall that defines a body tube 30 having an inner surface 32 thereof. The body tube 30 concentrically houses a working piston assembly 34 therein. The working piston assembly 34 can include a piston head that is threaded or otherwise connected to a piston rod 38, and the working piston assembly 34 can have a wear band that forms a sliding seal against the inner surface 32 of body tube 30. In some embodiments, the piston assembly 34 includes an elastomeric rebound bumper 35 that sits atop the piston head and is configured to deform and absorb energy in response to being axially squeezed between the piston head and another structure. In other words, if a maximum rebound length of monotube shock absorber 12 establishes a suspension maximum droop travel value, then rebound bumper 35 will cushion the internal, piston head stopping, collision that occurs during instances of full rebound.

Still referring to FIGS. 2-4, the working piston assembly 34 can include a piston valving assembly 36 that is configured to at least at times allow oil to flow through or around the working piston assembly 34. This correspondingly provides certain damping characteristics to the monotube shock absorber 12. For example, due to the piston valving assembly 36 configurations, at certain stroking speeds, predetermined pressure differentials are established across the working piston assembly 34. In other words, the piston valving assembly 36 is configured so that during a certain stroking speed, a desired pressure differential is established across the working piston assembly 34 to correspond to the desired damping characteristics as such stroking speed.

The piston valving assembly 36 can include any of a variety of suitable valve-type devices. In some implementations, the piston valving assembly 36 functions as a one-way valve or a check valve, permitting fluid flow through the piston head during a compression stroke and preventing fluid flow through the piston head during a rebound stroke. This configuration is preferred when it is desired to provide a substantial amount of damping adjustability during rebound strokes, by way of manipulating the control valve assembly 80, explained in greater detail elsewhere herein.

Piston valving assembly 36 can include, e.g., a plate mounted between the piston head and the piston rod 38. Such plate can define a piston stop that limits axial movement of the working piston assembly 34 within the body tube 30, and it can serve as positioning or supporting structure for an annular bypass spring, which may, for example, be a wave washer. The bypass spring can bias a bypass valve system to a sealing position in which it covers and seats against an upper surface of the piston head, sealing closed one or more bypass passages that extend axially through or around the piston head.

Other suitable valving type structures can be incorporated into the piston valving assembly 36, which are well known to those skilled in the art and well within the scope of this invention, including but not limited to, e.g., fluted passages at or adjacent the outer perimeter of the piston head, and/or others. Such other suitable known valve-type devices can be provided to cooperate with the working piston assembly 34, and are configured so that at a certain stroking speed and thus oil flow rate through or around the working piston assembly 34, a desired pressure differential is established across the working piston assembly 34 that correspond to the desired damping characteristics at such stroking speed. Regardless of the particular configuration of piston valving assembly 36 and its corresponding damping characteristics, such damping characteristics can then be tuned, adjusted, modified, and/or otherwise regulated by manipulating a control valve assembly 80, explained in greater detail elsewhere herein, either remotely or otherwise.

Stated another way, the piston valving assembly 36 can be configured to provide or at least partially influence a base or default value of, for example, (i) bleed performance characteristics that are established at relatively lower shaft velocities, and/or (ii) blow-off performance characteristics that are established at relatively greater shaft velocities and which tend to define substantially degressive damping characteristics. These and/or other performance characteristics of the monotube shock absorber 12 can then be remotely or otherwise adjusted as desired by way of the control valve assembly 80.

Still referring to FIGS. 2-4, body tube 30 can include a top wall that is sealed against the piston rod 38 in a conventional manner, allowing the rod 38 to slidingly advance and regress therethrough while maintaining a fluidly tight seal therebetween. This can be accomplished in any of a variety of suitable ways, including providing the top wall with one or more rod seals, other hydraulic seals, and/or rod scrapers that can also function to reduce the likelihood of dirt or other contamination to enter the inside of body tube 30. The other end or lower portion or end of body tube 30 is attached to a base 50.

Base 50 preferably houses a control valve assembly 80 that is adjustable for metering, varying, and/or otherwise influencing flow characteristics of the oil within at least portions of the monotube shock absorber 12. In this regard, control valve assembly 80 can modify the default damping characteristics established by the piston valving assembly 36, allowing the user to adjust, customize, or otherwise control damping characteristics of the shocks 12, preferably from a remote location.

Referring yet further to FIGS. 2-4, the control valve assembly 80 can include a variable flow-restricting valve, or other suitable device(s) for influencing flow rates through various portions of the monotube shock absorber 12. For example, control valve assembly 80 can include a valve plate and retainer that hold a spring therebetween for biasing a first end of a pin away from or axially out of an oil passage. In some implementations, a second end of the valve pin can be driven by a coaxially aligned piston for overcoming the spring biasing force and correspondingly forcing the first end of the pin nearer or axially into the oil passage.

In such configuration of control valve assembly 80, by axially advancing or regressing the pin into or out of the oil passage, an effective clearance between an inner circumferential surface of the passage and outer circumferential surface of the pin can be varied. Varying the relative dimensions of such clearance in this regard correspondingly influences flow volume and rate therethrough, whereby damping characteristics of the monotube shock absorber may be defined as a function of axial or other pin position within the passage. This allows a user to influence performance characteristics of the monotube shock absorber(s) by manipulating pin position within the oil passage, whether such manipulation occurs manually, hydraulically, pneumatically, electronically, or by using combinations of such techniques.

Various suitable exemplary control valve assemblies 80 can be seen in U.S. Pat. No. 4,838,394, entitled ADJUSTABLE SHOCK ABSORBER AND SYSTEM, which is incorporated by reference herein in its entirety, while noting that other suitable control valve assemblies 80 are well within the scope of the invention. Regardless of the particular configuration of valve assembly 80, it preferably controls fluid flow through a passage that is fluidly connected with a bypass tube 100, such that manipulating the control valve assembly 80 influences flow characteristics into and/or through the bypass tube.

Referring yet further to FIGS. 2-4, bypass tube 100 is external of the body tube 30 and connected to an outer circumferential surface while being in fluid communication with an interior portion of the body tube 30. A first lower end 102 of bypass tube 100 can be fluidly connected to the valve assembly, for example, by way of a passage extending through a respective portion of the base 50. A second upper end 104 of the bypass tube 100 is connected to the body tube 30 and empties into its interior. The particular locations of connection of the lower and upper ends 102 and 104 to the monotube shock absorber 12 are selected based on the particular end use design thereof The lower end 102 attaches to a point that is below a lowermost position of working piston assembly 34 during use and the upper end 104 attaches to a point that is above an uppermost position of the working piston assembly 34 during use.

Stated another way, (i) the upper end 104 of bypass tube 100 is preferably connected to body tube 30 at a position that is above the working piston assembly 34 when the piston rod 38 is fully extended out of the body tube 30 so that the working piston assembly 34 is in its uppermost extreme position, and (ii) the lower end 102 of bypass tube 100 is preferably connected to base 50 of body tube 30 at a position that is below the working piston assembly 34 when the piston rod 38 is fully advanced into the body tube 30 so that the working piston assembly 34 is in its lowermost extreme position. Regardless of the exact connecting location(s) along body tube 30, both the lower and upper ends 102 and 104 open into a portion of the body tube 30 that contains oil, whereby the bypass tube 100 is completely filled with oil and not gas at all times during use.

It is noted that since oil is an incompressible fluid, the monotube shock absorber 12 includes not only a volume of oil but also a volume of a compressible fluid, such as a volume of gas, therein for, e.g., accommodating thermal expansion and/or contraction of the oil during use, and/or for various other reasons such as facilitating rod travel. Since the bypass tube 100 is always filled with oil during use, the location in monotube shock absorber 12 at which the gas is housed will influence what particular position the upper end 104 of bypass tube 100 can connect to the body tube 30.

Referring specifically now to FIG. 2, in some implementations, the volume of gas is housed in an upper end of the body tube 30 and therefore above the volume of oil. In such embodiments, the monotube shock absorber 12 can include an optional floating piston 120 that axially separates the volumes of oil and gas, maintaining the fluid separation therebetween, and can be concentrically housed between and slidingly (but also sealingly) interfacing with each of the piston rod 38 and the inner surface 32 of body tube 30. The floating piston 120 is configured to axially move with respect to the piston rod 38 and the inner surface 32 of body tube 30, whereby a floating zone is defined by the area or length along which the floating piston 120 axially traverses. Since the floating piston 120 can axially move or float, it is able to dynamically move and change the volume of the gas segment to, for example, accommodate thermal expansion or contraction-based changes, in oil volume or other variables within the monotube shock absorber 12, and also to accommodate rod displacement oil.

Referring now to FIGS. 3-5, in some implementations, the body tube 30 can be filled with oil in its entirety, whereby the upper end 104 of bypass tube 100 can connect adjacent or otherwise near the topwall body tube 30. In these embodiments, the volume of gas is held in an external reservoir 150. The external reservoir 150 preferably also holds a volume of oil therein and the volumes of gas and oil may again be physically separated with an optional floating piston 120. A tube 155 can connect the external reservoir 150 to the remainder of monotube shock absorber 12, for example, at the base 50, fluidly connecting the external reservoir to a desired portion of the interior of the base 50 and/or body tube 30.

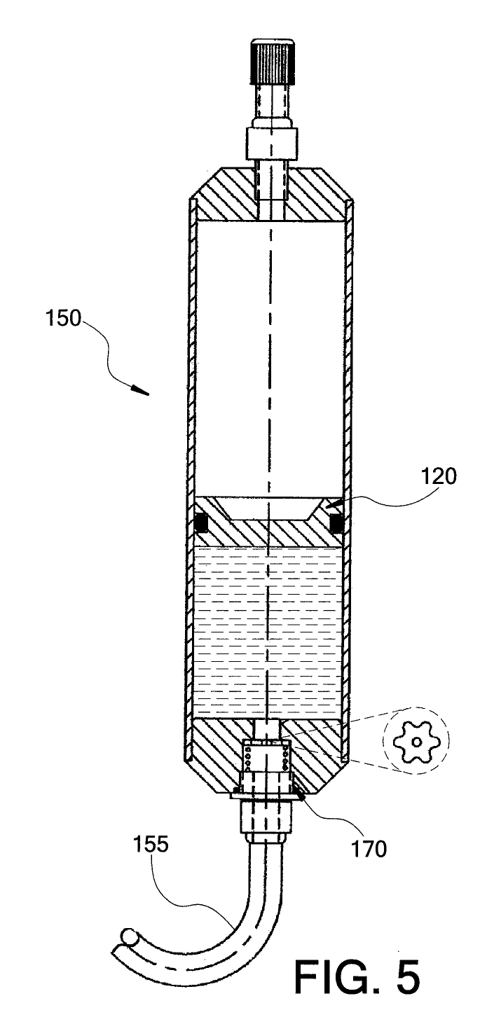

Referring specifically now to FIG. 5, an anti-cavitation valve 170 can be provided between the working piston assembly 34 and the floating piston 120, for example, by mounting the anti-cavitation valve in a bottom wall or base of the external reservoir 150. The anti-cavitation valve 170 allows a lower static pressure to be maintained in a resting, default, or non-actuating state of the monotube shock absorber 12. Anti-cavitation valve 170 facilitates dynamic pressure accumulation so that at any given point in time, the overall monotube shock absorber 12 functions as though, at that instant, the monotube shock absorber 12 was charged with at greater static pressure than its actual static pressure.

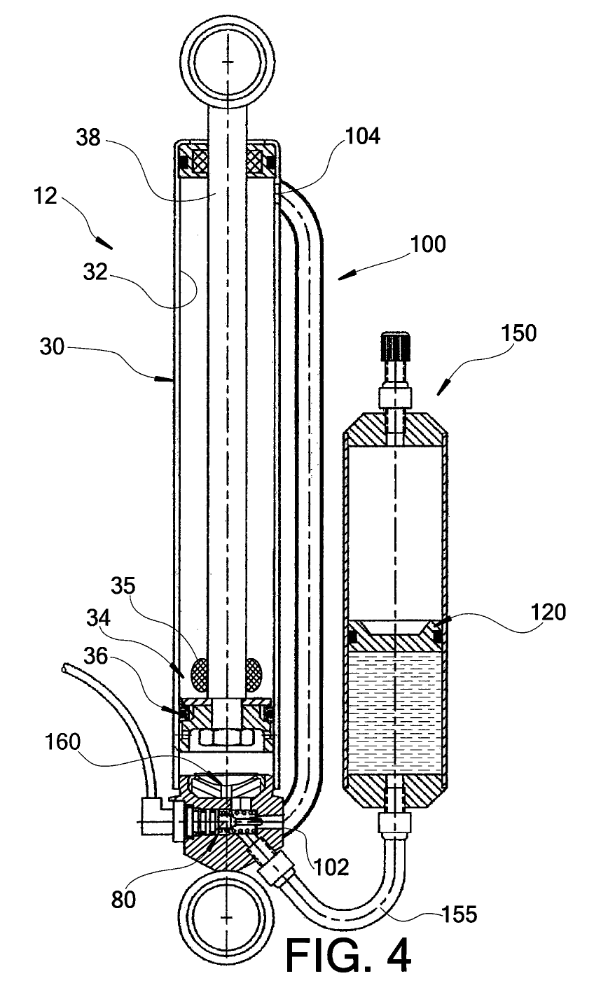

In light of the above, during use, the particular operation(s) of the monotube shock absorber 12 will depend on its particular configuration. For example some implementations of monotube shock absorber 12, such as those seen in FIGS. 2 and 3, create a bidirectional flow pattern through the bypass tube 100 during use, whereas other implementations, such as that seen in FIG. 4, creates a mono-directional flow pattern through its bypass tube 100.

Referring now to FIGS. 2 and 3, the bi-directional flow pattern is established in which oil flows through the bypass tube 100 in a direction that corresponds to a travel direction of the working piston assembly 34. For example, when the working piston assembly 34 travels downwardly into the body tube 30 during a compression stroke, a volume of oil, e.g., the compression oil, will initially flow backward through the control valve assembly 80 and then up the bypass tube 100. As the compression stroking speed increases, oil will begin to also flow through the piston valving assembly 36. If monotube shock absorber 12 is equipped with an external reservoir (FIG. 3), at that time, rod displacement oil will flow into the external reservoir 150.

Still referring to FIGS. 2 and 3, when the working piston assembly 34 travels in the opposite direction, e.g., upwardly through the body tube 30 during a rebound stroke, all rebound oil must ideally flow down the bypass tube and into and/or through the control valve assembly 80. During a rebound stroke, all of the oil which was previously displaced during a compression stroke will backfill behind the piston. If monotube shock absorber 12 is equipped with an external reservoir (FIG. 3), at that time, external reservoir oil will add to the backfill oil to the extent that corresponds to, e.g., a swept volume of the rod.

Referring now to FIG. 4, as desired, in lieu of the above-discussed bidirectional flow pattern, as desired, monotube shock absorber 12 can be configured to establish a mono-directional flow pattern through the bypass tube 100. Namely, in some alternative embodiments of monotube shock absorber 12, such as that seen in FIG. 4, a foot valve 160 is provided in fluid communication with the interior of the body tube 30, control valve assembly 80, and bypass tube 100, whereby a mono-directional flow pattern is established through the bypass tube such that during both compression and rebound phases, oil flows through the bypass tube 100 in a single direction.

Referring again to FIG. 2, yet other performance and operational characteristics of the monotube shock absorber 12 can be determined based on the particular end use configuration. For example, when a relatively greater damping force per a given stroke speed is desired, then the monotube shock absorber 12 of FIG. 2 that is devoid of an external reservoir 150 while including a bypass tube 100 that is positioned below a lowermost floating zone segment can be implemented. When the gas volume is above the working piston assembly 34, relatively more oil must cross the piston assembly 34 during a compression stroke than if the gas volume is below the piston assembly 34. This can lead to a higher pressure drop for a given stroking speed, and therefore a higher damping force.

Still referring to FIG. 2, likewise, if the gas volume is above the working piston assembly 34, relatively more oil has to cross the piston assembly 34 during a rebound stroke than if the gas volume is below the piston assembly 34. In other words, when the gas volume is positioned above the working piston assembly 34, as seen in FIG. 2, relatively more oil is displaced across the working piston assembly 34 on any given stroke than if the gas volume is positioned below the working piston assembly. In this configuration, higher damping forces are realized for a given stroking speed.

Furthermore and still referring to FIG. 2, during instances of full rebound, or full withdrawal of rod 38, the volume of gas and the floating piston 120 cooperate with the piston assembly 34 serve as a pneumatic rebound limiter which pneumatically supplements the function of the elastomeric rebound bumper 35. During use, as the piston head approaches its upper most travel position, the upper surface of rebound bumper 35 collides with the lower surface of floating piston 120. Upon so doing, the rebound bumper 35 deforms as the piston head drives yet further upwardly, such that the piston head and rebound bumper 35 drive the floating piston 120 upwardly toward the uppermost floating zone segment. This compresses the gas above floating piston 120, reducing the volume and increasing the pressure of the gas, and correspondingly resisting and slowing down the further upward travel of the piston head. In this configuration, the gas serves as an air spring that supplements the rebound bumper 35, increasing the duration of time over which the piston head decelerates which renders the rebound stroke limit occurrence relatively less harsh.

Of course, it should be understood that a wide range of changes and modifications can be made to the preferred embodiments described above. It is therefore intended that the foregoing detailed description be regarded as illustrative rather than limiting, and that it be understood that it is the following claims, including all equivalents which are intended to define the scope of this invention.

What we claim is:

1. A monotube shock absorber comprising:
(a) a body tube having a cylindrical sidewall and defining,
(i) a gas cavity that houses a volume of gas therein; and
(ii) an oil cavity axially adjacent the gas cavity and housing a volume of oil therein;
(b) a rod having a first end housed in the body tube and a second end extending outwardly from an end of the body tube;
(c) a floating piston concentrically housed between the rod and an inwardly facing surface of the body tube cylindrical sidewall and defining,
(i) an interface between the gas and oil cavities and maintaining physical separation between the volumes of gas and oil; and
(ii) a floating zone corresponding to a portion of the body tube in which the floating piston axially traverses during use;
(d) a working piston connected to and traveling in unison with the first end of the rod and being positioned within and movable through the volume of oil, the working piston separating the oil cavity into,
(i) an upper oil cavity portion that is above the working piston, and
(ii) a lower oil cavity portion that is below the working piston; and
(e) an external bypass tube located outside of the body tube cylindrical sidewall and having,
(i) a lower bypass tube end fluidly connected to the lower oil cavity; and
(ii) an upper bypass tube end fluidly connected to the upper oil cavity portion,
wherein the upper bypass tube end intersects the body tube cylindrical sidewall at a location that is below a lowermost segment of the floating zone in which the floating piston operates.

2. The monotube shock absorber of claim 1, wherein the external bypass tube defines a bidirectional flow of oil therethrough when the working piston travels in a first axial direction and a second, opposing axial direction through the oil cavity.

3. The monotube shock absorber of claim 2, wherein a control valve is provided between the lower bypass tube end and the lower oil cavity portion and wherein adjusting the control valve influences oil flow characteristics within the monotube shock absorber.

4. The monotube shock absorber of claim 3, wherein the control valve is provided within a base that attaches to a bottom end of the body tube.

5. A monotube shock absorber comprising:
(a) a body tube having a cylindrical sidewall and defining an oil cavity that houses a volume of oil therein,
(b) a rod having a first end housed in the body tube and a second end extending outwardly from an end of the body tube;
(c) a working piston connected to and traveling in unison with the first end of the rod and being positioned within and movable through the volume of oil, the working piston separating the oil cavity into,
(i) an upper oil cavity portion that is above the working piston, and
(ii) a lower oil cavity portion that is below the working piston; and
(d) an external bypass tube located outside of the body tube cylindrical sidewall and fluidly connecting the upper and lower oil cavity portions with each other;
(e) an external reservoir housing a volume of gas and a volume of oil that is fluidly connected to the lower oil cavity; and
(f) a control valve operably positioned between the lower oil cavity and an end of the external bypass tube, such that a fluid flow path is defined between the control valve and the external bypass tube,
wherein adjusting the control valve influences oil flow characteristics within the monotube shock absorber.

6. The monotube shock absorber of claim 5, wherein an anti-cavitation valve is operably coupled to the external reservoir.

7. A monotube shock absorber comprising:
(a) a body tube having a cylindrical sidewall and defining an oil cavity that houses a volume of oil therein,
(b) a rod housed concentrically in the tube and having an end that extends outwardly from an end of the body tube;
(c) a working piston assembly having
(i) a piston head connected to the rod and slidingly communicating with an inner surface of the body tube cylindrical sidewall, and
(ii) a piston valving assembly permitting a volume of oil to flow axially through or past the piston head when a predetermined pressure differential is established across the piston head;
(d) a base connected to a lower portion of the body tube;
(e) an external bypass tube located outside of the body tube cylindrical sidewall, the external bypass tube having
(i) a first end attached to a location of the body tube cylindrical sidewall that is located above the piston head when the piston head is located at an uppermost position within the body tube during a rebound stroke, and
(ii) a second end attached to the base; and
(f) a control valve housed in the base and influencing a rate of flow of oil through the external bypass tube,
wherein during the rebound stroke, the piston head forces a volume of oil through a single flow path that is defined through the external bypass tube and the control valve such that manipulating the control valve adjusts rebound damping characteristics of the monotube shock absorber.

8. A remotely controlled monotube shock absorber system, comprising:
a user interface and a controller operably communicating with the user interface, the controller managing performance characteristics of multiple adjustable monotube shock absorbers, each of the multiple adjustable monotube shock absorbers including,
(a) a body tube having a cylindrical sidewall and defining an oil cavity that houses a volume of oil therein;
(b) a working piston displacing the volume of oil within the body tube;
(e) an external bypass tube located outside of the body tube cylindrical sidewall and fluidly connecting a first portion of the body tube and a second portion of the body tube; and
(f) a control valve controlling a rate of flow of oil through the external bypass tube,
wherein the controller manipulates the control valve of each of multiple monotube shock absorbers for simultaneously adjusting performance characteristics of the multiple monotube shock absorbers.
